(19) United States
(12) Patent Application Publication
(10) Pub. No.: US 2005/0273855 A1
(43) Pub. Date: Dec. 8, 2005

(54) Method for preventing attacks on a network server within a call-based-services-environment and attack-prevention-device for executing the method

(75) Inventors: Karsten Oberle, Mannheim (DE); Marco Tomsu, Ditzingen (DE); Peter Domschitz, Stuttgart (DE); Jurgen Otterbach, Stuttgart (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/111,761

(22) Filed: Apr. 22, 2005

(30) Foreign Application Priority Data
Jun. 7, 2004 (EP) 04291418.4

(51) Int. Cl. H04L 9/00

(52) U.S. Cl. 726/22

(57) ABSTRACT

The invention refers to a method for preventing attacks on a network server within a call-based-services-environment, preferably a VoIP-environment. The environment comprises a network, the network server connected to the network, a number of user agents connected to the network and means for restricting access to the network server from the network. The call server comprises an attack-detection device for detecting and identifying attacks from the network on the network server. In order to allow fast and reliable protection of the network server against attacks it is suggested that characteristic parameters of the attacks identified are entered into a black-list, the content of the black-list is transmitted via a feedback-path to an attack-prevention-device for controlling the access restricting means, the attack-prevention-device inspects and analyzes traffic directed from the network to the network server and controls the access restricting means.

### BACKGROUND OF THE INVENTION

The invention is based on a priority application EP 04291418.4 which is hereby incorporated by reference.

The present invention refers to a method for preventing attacks on a network server. The server is connected to a network. Data is transmitted between the network server and the network across means for restricting access to the network server. The network server comprises an attack-detection-device for detecting and identifying attacks from the network on the network server.

Furthermore, the invention refers to an attack-prevention-device for preventing attacks on a network server connected to a network via means for restricting access to the network server from the network. The attack-prevention-device is adapted to control the access restricting means.

The method and the attack-prevention-device, for example, can be used for preventing attacks on a call server within a call-based-services-environment. In that case, the network server would be a so-called call server. The call-based-services-environment can also be referred to as session-based-services-environment. Examples for call-based-services are Voice-over-Internet-Protocol (VoIP)-services or multi-media-services. Call-based or session-based means that data transmission across the network is initiated by a call.

A call server is adapted to control the set-up, maintenance and tear-down of a data-transmission-connection (i.e. communication link or media-path) to be established between at least one first user agent and at least one second user agent across the network. Signaling messages are used for controlling the communication link. Of course, the network-environments within which the present invention is realized can comprise more than one network server, all connected to the network. A call server comprises means for establishing calls through the network. The user agents can be IP-telephones or any kind of computers equipped with appropriate audio/visual and networking hardware, and appropriate signaling software. The access restricting means usually are referred to as a firewall. Firewalls can be individually controlled in order to let certain messages pass through from the network to the call server and to filter, block and/or throttle other messages.

Protocols used to signal Voice-over-IP (VoIP) connections are, for example, the Session Initiation Protocol (SIP), H.323.

It is known from the state of the art to install a device with static packet filtering rules and bandwidth limitation (for example on SIP-signaling default port 5060) between a SIP call server (so called SIP proxy server) and the network in order to protect the SIP proxy server from overload. However, such a device cannot detect and remove malicious SIP messages attacking the SIP proxy server.

Furthermore, dynamic border gate technologies (for example the Aravox firewall from former Aravox Technologies Inc., 4201 Lexington Avenue North, Suite 1105, Arden Hills, Minn. 55126, USA, recently taken over by Alcatel) are known in the art, which offer layer 3 and 4 firewalling, flow-based pinholing and bandwidth limitation. As dynamic firewalling concept it is controlled by a MIDCOM-style interface. Firewall rules are compiled and inserted into the access-restricting means (firewall logic). Usually, at present only the media path and not the signaling path is considered.

To detect attacks, the call server itself may have the ability to internally classify all received messages and then to remove the malicious messages after inspection directly at the input. Though this keeps the call server from holding too many uncompleted call states in memory, it does not inhibit the overload situation at the call server input because messages have to reach the call server, where each message is classified and removed in case it is malicious. This means that in the art messages indeed have to be processed but eventually are deleted, hopefully without causing any harm to the call server.

Since the firewall in front of the call server itself has no application awareness, in particular it cannot differentiate between correct messages and attacks, all messages have to reach the call server for inspection. This means that the ratio of valid to malicious messages at the input of the call server is not changed and the availability of the call server for valid callers remains unsatisfying. So static packet filtering rules and bandwidth limitation give only a very basic security to the call server, as long as not all application information (messages) is thoroughly checked.

The known methods for preventing attacks on a call server within a VoIP-environment usually have an attack-detection-device assigned to or even incorporated into the call server. The attack-detection-device comprises algorithms and rules for analyzing the traffic received by the call server and for detecting potential attacks. For example, the call server can observe the call completion rate (CCR). If the CCR is below a certain level, this may be a sign for a denial of service (DoS)-attack or a distributed DOS (DDoS)-attack on the call server. In that case the attacking user agent sends numerous signaling messages to the call server requesting the set-up of VoIP-communication links to other user agents (for example, “Invite”-messages in SIP). The attack can be driven from one user agent (DoS-attack) or from numerous distributed user agents (DDoS-attack). Another sign for an attack on the call server is an exaggerated number of call attempts per second (CAPS). For example an exaggerated 10.000 CAPS/sec. instead of a normal number of about 100 to 200 CAPS/sec. indicates an attack on the call server).

In the state of the art, the access restricting means are controlled directly by the call-server. This means that the call-server has to handle and process each message coming in, even if later on during firewalling it is regarded as a malicious message and is consequently removed. Processing and handling of each messages provokes an excessive workload for the call server.

### SUMMARY OF THE INVENTION

It is an object of the present invention to provide a method for preventing attacks on a call server within a VoIP-environment, the method on the one hand assuring a secure and reliable filtering of malicious messages destined for the call server and on the other hand reducing the workload of the call server for handling, processing and filtering the messages coming in.

This object is achieved by a method of the kind mentioned above which is characterized by the following steps:
characteristic parameters of the attacks identified are entered into a black-list,
the content of the black-list is transmitted to an attack-prevention-device for controlling the access restricting means,
the attack-prevention-device inspects and analyzes traffic directed from the network to the network server and controls the access restricting means according to the content of the black-list and according to the characteristic parameters of the traffic analyzed, and
the access restricting means restrict access from the network to the network server according to control commands received from the attack-prevention-device.

According to the present invention an advanced method is provided by a fast and highly responsive combination of an attack-detection-device with an attack-prevention-device operating with a special black-list. The type and realization of the attack-detection-device is not part of the present invention. In a possible embodiment, the detection-device should be easily programmable, in order to quickly react on concrete new attacking types and scenarios. The attack-detection-device can be disposed separately from the network server. Alternatively, it can be partly or completely included within the network server.

It is necessary to derive distinguishing information of conspicuous or malicious messages of the traffic, for example characteristic attributes and parameters of these messages. The distinguishing information is entered in the black-list and is used by the attack-prevention-device for distinguishing malicious messages (making part of an attack) from normal messages (making part of a signaling procedure or of a media flow).

The attack-prevention-device can perform thorough data packet inspection and pattern matching operations, in order to achieve filtering, blocking and/or throttling of messages, whose distinguishing information matches with the distinguishing information contained in the black-list. A possible most efficient pattern matching method can be easily implemented as hash table look-ups. Although the attack-prevention-device can perform inspection and analyzing operations, that is it can identify the content of the inspected messages, it does not understand the content of the messages or perform any processing of the content. The attack-prevention-device can scan any kind of data for a certain content, irrespective of the protocol of the data transmission and/or a signaling protocol.

The content of the black-list is an important issue of the present invention. The black-list holds the complete information required by the attack-prevention-device to handle each message or each data-packet respectively addressed to the network server. The content of the black-list is created by the attack-detection-device according to certain definition parameters for defining the messages or the data-packets.

The attack-prevention-device has a restricted intelligence. Its function can be compared to the duty of a gate-keeper, who has to control access to a restricted area (corresponding to the network server). The gate-keeper looks at a person (corresponding to the messages), who desires access into the restricted area, and has to decide according to certain algorithms, rules or lists, etc. (contained in the black-list) whether the person is allowed in or not. Depending on the outcome of the gate-keeper's decision, the gate-keeper opens the gate (corresponding to the access restricting means) and lets the person pass or leaves the gate closed and refuses entrance of the person. The gate-keeper acquires no knowledge why the person wants to enter the restricted area or what the person carries with him. The gate-keeper simply checks, whether certain obvious conditions are fulfilled (for example, if the person carries a weapon, or if the person carries an appropriate ID-card) and lets the person pass through or refuses entrance of the person accordingly.

The attack-prevention-device is blocking or limiting traffic destined to the network server, based on the content of the black-list. The black-list, for example, contains patterns or attributes, describing malicious or conspicuous traffic. In a Voice-over-Internet-Protocol (VoIP)-environment, possible attributes or patterns could be for example in SIP: “to”-, “from”-, “via”-fields, IP-addresses, TCP (Transmission Control Protocol)/UDP (User Datagram Protocol)-ports, etc. and combinations thereof. The patterns and attributes are created by the attack-detection-device, are entered into the black-list and are transferred to the attack-prevention-device. The patterns and attributes can be entered into the black-list in the realm of the attack-detection-device and then be transmitted to the attack-prevention-device in the black-list. In this case the black-list is created by the attack-detection-device and transmitted as a whole to the attack-prevention-device.

Alternatively, the patterns and attributes of messages identified to be conspicuous or malicious can be transmitted to the attack-prevention-device and entered into the black-list in the realm of the attack-prevention-device. This has the advantage that every time the black-list is updated, only the changes of the patterns and attributes and not the entire black-list have to be transmitted to the attack-prevention-device.

According to a preferred embodiment of the present invention it is suggested that the network server is a call server making part of a call-based-services-environment. The environment comprises the network, the call server connected to the network and at least one user agent connected to the network. The call server is adapted for setting up a data transmission connection between the at least one user agent and at least one other user agent by means of signaling messages. The signaling messages are transmitted between the call server and the user agents across the network and across the access restricting means. The attack-prevention-device inspects and analyzes the signaling messages of the traffic directed from the network to the call server. Preferably, the call-based-services-environment is a Voice-over-Internet-Protocol (VoIP)-environment.

It is suggested that patterns and/or attributes defining conspicuous or malicious traffic directed from the network to the network server are entered in the black-list as characteristic parameters. Preferably, the patterns and/or attributes defining traffic directed to the network server are identified as being conspicuous or malicious by the attack-detection-device. For that purpose, attributes and characteristics of the malicious and conspicuous traffic messages have to be derived and defined before the method according to the invention can be properly executed. In SIP, for example, the combination of attributes depends on the scenario and the a-priori knowledge of the SIP provider. For example, if address spoofing is inhibited for its network access customers, a filtering can leverage the relation between the SIP “from”-field and the IP source address, so that DoS-attacks from its own realm can be blocked. If a DDoS-attacker uses a specific pattern within any SIP-header field—or specific meta information between the regular header fields—it can be detected and blocked at wire-speed.

According to a preferred embodiment of the present invention, the content of the black-list is constantly and dynamically updated during operation of the network server.

According to another preferred embodiment of the invention, it is suggested that the content of the black-list is transmitted to the attack-prevention-device via a feedback-path. According to this embodiment, a path for data-transmission is provided between the attack-detection-device and the attack-prevention-device. Preferably, the path allows wire-speed data transmission.

According to yet another preferred embodiment of the invention, the steps of
detecting and identifying attacks from the network on the network server,
entering the characteristic parameters of the attacks identified into the black-list,
transmitting the content of the black-list to the attack-prevention-device,
analyzing the traffic directed from the network to the network server and controlling the access restricting means according to the content of the black-list and according to the characteristic parameters of the traffic analyzed, and
restricting access from the network to the network server according to the control commands received from the attack-prevention-device
   are preformed at wire-speed. The processing at wire-speed is also called real-time-processing or non-blocking-processing. Wire-speed-processing in the attack-detection-device and the attack-prevention-device means that the overall rate of processing must at least correspond to the desired maximum bandwidth for transmitting messages across the network to the network server in any operating condition of the VoIP-environment. Preferably the rate of processing is higher than the maximum bandwidth for transmitting messages across the network in order to ensure wire-speed processing even in the worst-case.

It is suggested that the attack-prevention-device performs an inspection and analysis of the traffic directed from the network to the network server, in order to determine whether the messages directed to the network server correspond to or comprise patterns and/or attributes contained in the black-list. In particular, the analysis of the traffic comprises comparing the characteristic parameters entered into the black-list and defining traffic identified as being conspicuous or malicious.

Preferably the attack-prevention-device performs a filtering, blocking and/or throttling of the inspected traffic whose characteristic parameters match with the characteristic parameters entered into the black-list and defining traffic identified as being conspicuous or malicious. For performing the filtering, blocking and/or throttling of the inspected messages of the traffic, the attack-prevention-device sends appropriate control signals to the access-restricting-means. Of course, the attack-prevention-device and the access-restricting-means can be incorporated in a single common device, which can be referred to as a session-enabled-firewall.

It is particularly important to prevent attacks on the network server with conspicuous or malicious signaling messages. Therefore, it is suggested that the attack-prevention-device performs an inspection and analysis of signaling messages of the traffic directed from the network to the network server. Preferably, the attack-prevention-device performs an inspection and analysis of signaling messages according to the SIP (Session Initiation Protocol)-standard. Alternatively, the attack-prevention-device performs an inspection and analysis of signaling messages according to the H.323-standard.

Further, the above-mentioned object is achieved by an attack-prevention-device of the kind mentioned above, comprising
input means for receiving a black-list comprising characteristic parameters on attacks from the network on the network server, the attacks being detected and identified by an attack-detection-device making part of the network server,
means for performing an inspection and analysis of the traffic directed from the network to the network server, and for determining characteristic parameters of the traffic,
means for creating control signals for the access restricting means according to the content of the black-list and according to the characteristic parameters of the traffic analyzed, and
output means for transmitting the control signals to the access restricting means.

According to a preferred embodiment of the invention it is suggested that the means for performing an inspection and analysis of the traffic directed from the network to the network server inspect and analyze signaling messages of the traffic. In particular, it is suggested that the network server is a call server making part of a call-based-services-environment. The environment comprises the network, the call server connected to the network and at least one user agent connected to the network. The call server is adapted for setting up a data transmission connection between the at least one user agent and at least one other user agent by means of signaling messages. The signaling messages are transmitted between the call server and the user agents across the network and across the access restricting means. The means for performing an inspection and analysis of the traffic inspect and analyze the signaling messages of the traffic directed from the network to the call server.

Preferably, the means for performing an inspection and analysis of the traffic directed from the network to the call server inspect and analyze signaling messages according to a SIP (Session Initiation Protocol)-standard.

According to another preferred embodiment of the invention it is suggested that the black-list contains patterns and/or attributes describing malicious and/or conspicuous traffic and that the means for performing an inspection and analysis of the traffic directed from the network to the network server perform a pattern and/or attribute matching operation in order to determine whether the inspected and analyzed traffic comprises an attack on the network server.

### BRIEF DESCRIPTION OF THE DRAWINGS

Further features and advantages of the present invention are explained in more detail below with reference to the accompanying drawings. The figure shows:

FIG. 1 a general view of a Voice-over-IP (VoIP)-environment, in which the method according to the present invention can be executed.

### DETAILED DESCRIPTION OF THE DRAWINGS

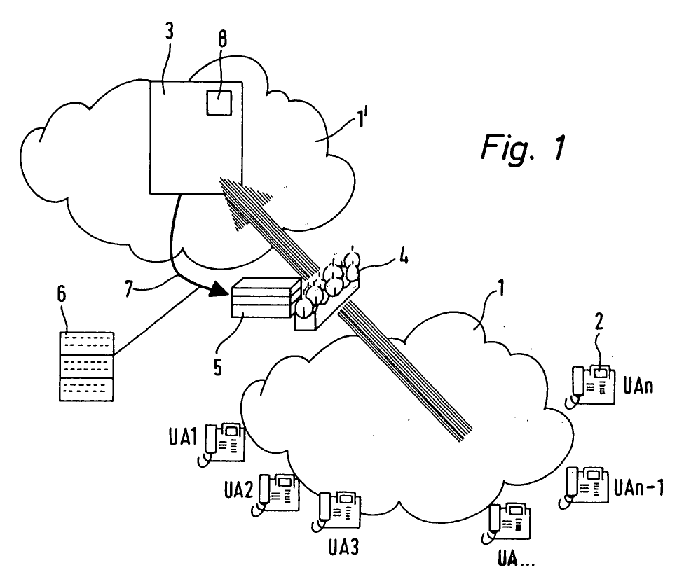

Now by way of example and referring to FIG. 1, the present invention will be described in more detail for a Voice-over-Internet-Protocol (VoIP)-environment, in particular comprising Session Initiation Protocol (SIP)-signaling. However, the present invention is not limited to SIP-signaling. Other signaling protocols, for example H.323-protocol, can be used, too. Furthermore, the invention is not limited to VoIP-environments. Rather, the present invention can be used for any kind of peer-to-peer communication link to be established or already established between the network server and any part of the network (e.g. other servers or user agents connected to the network). Finally, the invention is not limited to inspecting and analyzing signaling messages, but can be used for inspecting and analyzing payload messages (e.g. media information), too.

In FIG. 1 a VoIP-environment is shown, in which the method according to the present invention can be executed. The VoIP-environment uses SIP signaling messages. In FIG. 1 an Internet Protocol (IP) network is designated with reference number 1. Of course, any other kind of network protocol can be used, too. A number of User Agents UA1, UA2, UA3, . . . , UAn-1, UAn, all designated with reference sign 2 are connected to the IP-network 1. Furthermore, a call server 3, namely the SIP Proxy-Server, is connected to the IP-network 1. Access restricting means 4, namely a firewall, are disposed between the SIP Proxy-Server 3 and the IP-network 1. The firewall 4 prevents certain SIP-messages from reaching the SIP Proxy-Server 3 out of the IP-network 1. Therefore, that part of the IP-network 1 disposed beyond the firewall 4 can be regarded as the safe part or the secure side 1′ of the network 1. The firewall 4 does not perform any analyzing of the traffic directed to the call server 3. It is simply a gate without its own intelligence and controlled by one or more other entities in order to open or close it and to let certain data pass and to reject other data.

The firewall 4 is controlled by an attack-prevention-device 5, namely a SIP-gate. The SIP-gate 5 tells the firewall 4 when to open letting certain SIP-messages pass and when to close preventing certain SIP-messages from entering the secure-side 1′ of the network 1 and from reaching the SIP Proxy-Server 3. The SIP-gate 5 has a restricted intelligence allowing it to inspect and analyze incoming messages for the presence of certain characteristic parameters of the messages. The SIP-gate 5 does not understand the content of the scanned messages nor does it process the content to such an extent that it performs certain actions as a result of the content. This allows the SIP-gate 5 to work independent of the signaling protocol (e.g. SIP) used in the environment.

The SIP-gate 5 receives a so-called black-list 6 from the SIP-proxy-server 3 across a feedback-path 7. The black-list 6 comprises information on those SIP-messages, which are to be blocked or at least restricted in number. The black-list 6 does not contain individual information on each SIP-message to be blocked or restricted. Rather, the black-list 6 comprises characteristic parameters, for example certain patterns or attributes, defining that kind of SIP-messages, which is to be blocked or restricted. The SIP-gate 5 inspects and analyzes the SIP-messages directed to the SIP Proxy-Server 3 in order to determine, whether the inspected and analyzed SIP-messages comprise an attack on the SIP-proxy-server 3 or not. Inspecting and analyzing the SIP-messages comprises comparing the characteristic parameters of the inspected SIP-messages with the respective characteristic parameters contained in the black-list 6 and defining conspicuous or malicious SIP-messages. In particular, the inspection and analyses of the SIP-messages by the SIP-gate 5 comprises pattern- and/or attribute-matching operations. The firewall 4 and the SIP-gate 5 together constitute a so-called session enabled firewall.

The content of the black-list 6 is created in an attack-detection-device 8 situated in or near to the SIP Proxy-Server 3. The rules, attributes and/or patterns defining conspicuous and malicious SIP-messages are entered in the black-list 6 and then transmitted to the SIP-gate 5 across the feedback-path 7. Alternatively the rules, attributes and/or patterns defining conspicuous and malicious SIP-messages are transmitted to the SIP-gate 5 and entered in the black-list 6 there. The attack-detection-device 8 may perform a static attack-detection-algorithm for detecting attacking SIP-messages in a way, known in the art. It is possible that the attack-detection-device 8 performs new algorithms for detecting attacking SIP-messages as quickly and as reliably as possible, which are not known in the art. However, the algorithms used by the attack-detection-device 8 are not subject of the present invention.

A main issue of the present invention is the fact, that an intelligent device, namely the attack-detection-device 8, performs the actual detection of attacking SIP-messages and creates the rules, patterns and/or attributes for defining those SIP-messages, which constitute an attack on the SIP Proxy-Server 3. The rules, patterns and/or attributes for these SIP-messages are entered into the black-list 6. Furthermore, a device with restricted intelligence, namely the attack-prevention-device or the SIP-gate 5, performs the control of the firewall 4 depending on the content of the black-list 6. That has the advantage that conspicuous or malicious SIP-messages are blocked or restricted before and not after reaching the SIP-proxy-server 3. For inspecting and analyzing incoming SIP-messages, the SIP-gate 5 just looks at the content of the SIP-messages, for example at the information contained in the header or at the payload-information, but does not have to understand the content. The SIP-gate 5 has to perform simple pattern- and/or attribute-matching operations. The reduced intelligence of the SIP-gate 5 allows a very fast processing speed of the SIP-gate 5. Furthermore, the reduced intelligence of the SIP-gate 5 makes it very hard for potential attackers to actually drive an attack on the SIP-gate 5 thereby manipulating the firewall 4 and opening the way for a subsequent attack on the SIP Proxy-Server 3.

To allow a fast reaction on a detected attack on the SIP Proxy-Server 3, preferably the steps of:
detecting and identifying attacks from the IP-network 1 on the SIP-proxy-server 3,
entering the characteristic parameters defining the attacking messages into the black-list 6,
transmitting the content of the black-list 6 via the feedback-path 7 to the SIP-gate 5,
scanning, inspecting and/or analyzing the traffic directed from the IP-network 1 to the SIP Proxy-Server 3 and controlling the firewall 4 according to the content of the black-list 6 and according to the characteristic parameters of the traffic analyzed, and
restricting access from the IP-network 1 to the SIP Proxy-Server 3 according to the control commands received from the SIP-gate 5
   are performed at wire-speed. The content of the black-list 6 is constantly and dynamically updated during operation of the SIP Proxy-Server 3. However, as mentioned above, the content of the black-list 6 is used only for controlling the firewall 4. The detection of malicious and suspicious messages is performed independently from the black list 6 within the attack-detection-device 8 of the SIP-proxy-server 3. Therefore, changing the content of the black list 6 changes the behavior of the firewall 4 but has no influence on the detection of malicious and suspicious messages.

The idea of the present invention is to source out the low-level data-packet analyzing from the SIP Proxy-Server 3 to the SIP-gate 5. By doing so, malicious and conspicuous data-packets can be detected and removed by the firewall 4 before reaching the SIP Proxy-Server 3 and consuming resources there. However, only low-level analyzing is outsourced to the SIP-gate 5, in order to assure fast processing within the session enabled firewall 4, 5. Preferably the session enabled firewall 4, 5 works at wire-speed or in real-time.

1. Method for preventing attacks on a network server connected to a network, wherein data is transmitted between the network and the network server across means for restricting access to the network server, and wherein the network server comprises an attack-detection-device for detecting and identifying attacks from the network on the network server, and wherein
characteristic parameters of the attacks identified are entered into a black-list,
the content of the black-list is transmitted to an attack-prevention-device for controlling the access restricting means,
the attack-prevention-device inspects and analyzes traffic directed from the network to the network server and controls the access restricting means according to the content of the black-list and according to the characteristic parameters of the traffic analyzed, and the access restricting means restrict access from the network to the network server according to control commands received from the attack-prevention-device.

2. Method according to claim 1, characterized in that the network server is a call server making part of a call-based-services-environment, the environment comprising the network, the call server connected to the network and at least one user agent connected to the network, the call server being adapted for setting up a data transmission connection between the at least one agent and at least one other user agent by means of signaling messages, wherein the signaling messages are transmitted between the call server and the user agents across the network and across the access restricting means, and wherein the attack-prevention-device inspects and analyzes the signaling messages of the traffic directed from the network to the call server.

3. Method according to claim 2, characterized in that the method is used for preventing attacks on a call server within a Voice-over-Internet-Protocol-environment.

4. Method according to claim 1, characterized in that patterns and/or attributes defining conspicuous or malicious traffic directed from the network to the network server are entered in the black-list as characteristic parameters.

5. Method according to claim 1, characterized in that the content of the black-list is constantly and dynamically updated during operation of the network server.

6. Method according to claim 1, characterized in that the attacks are identified and the characteristic parameters are entered into the black-list by the attack-detection-device.

7. Method according to claim 1, characterized in that the content of the black-list is transmitted to the attack-prevention-device via a feedback-path.

8. Method according to claim 1, characterized in that the steps of
detecting and identifying attacks from the network on the network server,
entering the characteristic parameters of the attacks identified into the black-list,
transmitting the content of the black-list to the attack-prevention-device,
analyzing the traffic directed from the network to the network server and controlling the access restricting means according to the content of the black-list and according to the characteristic parameters of the traffic analyzed, and
restricting access from the network to the network server according to the control commands received from the attack-prevention-device are preformed at wire-speed.

9. Method according to claim 1, characterized in that the analysis of the traffic directed from the network to the network server comprises comparing the characteristic parameters of the inspected traffic with the characteristic parameters entered into the black-list and defining traffic identified as being conspicuous or malicious.

10. Method according to claim 9, characterized in that the attack-prevention-device performs a filtering, blocking and/or throttling of the inspected traffic whose characteristic parameters match with the characteristic parameters entered into the black-list and defining traffic identified as being conspicuous or malicious.

11. Method according to claim 2, characterized in that the attack-prevention-device performs an inspection and analysis of signaling messages according to a SIP-standard.

12. Method according to claim 2, characterized in that the attack-prevention-device performs an inspection and analysis of signaling messages according to a H.323-standard.

13. Attack-prevention-device for preventing attacks on a network server connected to a network via means for restricting access to the network server from the network wherein the attack-prevention-device is adapted to control the access restricting means, the attack-prevention-device comprising
input means for receiving a black-list comprising characteristic parameters on attacks from the network on the network server, the attacks being detected and identified by an attack-detection-device making part of the network server,
means for performing an inspection and analysis of the traffic directed from the network to the network server, and for determining characteristic parameters of the traffic,
means for creating control signals for the access restricting means according to the content of the black-list and according to the characteristic parameters of the traffic analyzed, and
output means for transmitting the control signals to the access restricting means.

14. Attack-prevention-device according to claim 13, characterized in that the network server is a call server making part of a call-based-services-environment, the environment comprising the network, the call server connected to the network and at least one user agent connected to the network, the call server being adapted for setting up a data transmission connection between the at least one user agent and at least one other user agent by means of signaling messages, wherein the signaling messages are transmitted between the user agents and the call server across the network and across the access restricting means, and wherein the means for performing an inspection and analysis of the traffic inspect and analyze the signaling messages of the traffic directed from the network to the call server.

15. Attack-prevention-device according to claim 14, characterized in that the means for performing an inspection and analysis of the traffic directed from the network to the call server inspect and analyze signaling messages according to a SIP-standard.

16. Attack-prevention-device according to claim 13, characterized in that the black-list contains patterns and/or attributes describing malicious and/or conspicuous traffic and that the means for performing an inspection and analysis of the traffic directed from the network to the network server perform a pattern and/ or attribute matching operation in order to determine whether the inspected and analyzed traffic comprises an attack on the network server.
